(19) United States
(12) Patent Application Publication
(10) Pub. No.: US 2017/0089248 A1
(43) Pub. Date: Mar. 30, 2017

(54) EXHAUST AFTERTREATMENT HOUSED BETWEEN CYLINDER HEADS

(71) Applicant: Cummins Inc., Columbus, IN (US)

(72) Inventors: Andrea M. Evans, Columbus, IN (US); Michael J. Ruth, Franklin, IN (US); David M. Barnes, Columbus, IN (US); Jason W. Mackey, Columbus, IN (US); Krishna Pradeep Chilumukuru, Columbus, IN (US); Rick Vaughan Lewis, JR., Franklin, IN (US)

(73) Assignee: Cummins Inc., Columbus, IN (US)

(21) Appl. No.: 15/277,823

(22) Filed: Sep. 27, 2016

Related U.S. Application Data
(60) Provisional application No. 62/233,537, filed on Sep. 28, 2015.

(51) Int. Cl. F01N 13/08; F01N 13/00; F01N 3/10; F01N 3/021; F02B 75/22; F01N 3/20

(52) U.S. Cl. CPC F01N 13/08; F02B 75/228; F01N 3/2066; F01N 3/106; F01N 3/021; F01N 13/009

(57) ABSTRACT

An apparatus includes an internal combustion engine having a plurality of cylinders allocated between a first bank having a first cylinder head and a second bank having a second cylinder head. A medial space is defined between the first bank and the second bank. An exhaust system is in fluid receiving communication with the internal combustion engine and in fluid providing communication with the atmosphere. The exhaust system includes an aftertreatment system that is disposed at least in part at the medial space between the first bank and the second bank of the internal combustion engine.

### CROSS-REFERENCE TO RELATED PATENT APPLICATION

This application claims the benefit of and priority to U.S. Provisional Patent Application 62/233,537 filed Sep. 28, 2015 to Evans et al., titled “Exhaust Aftertreatment Housed Between Cylinder Heads,” and the contents of which are incorporated herein by reference in their entirety.

### TECHNICAL FIELD

The present disclosure relates generally to the field of exhaust aftertreatment systems.

### BACKGROUND

In general, regulated emissions for internal combustion engines include carbon monoxide (CO), hydrocarbons (HC), nitrogen oxides (NOₓ) and particulates. Such regulations have become more stringent over recent years. For example, the regulated emissions of NO and particulates from diesel-powered engines are low enough that, in many cases, the emissions levels cannot be met with improved combustion technologies alone. To that end, exhaust aftertreatment systems are utilized to supplement improved combustion technologies to reduce the levels of harmful exhaust emissions present in exhaust gas. Such aftermarket treatments often incorporate temperature-dependent chemical reactions to reduce regulated emissions.

### SUMMARY

Various embodiments relate to an engine with an exhaust aftertreatment system. One example apparatus includes an internal combustion engine having a plurality of cylinders allocated between a first bank having a first cylinder head and a second bank having a second cylinder head. A medial space is defined between the first bank and the second bank. The vehicle further includes an exhaust system in fluid receiving communication with the internal combustion engine and in fluid providing communication with the atmosphere. The exhaust system includes an aftertreatment system disposed at least in part at the medial space between the first bank and the second bank.

Various other embodiments relate to methods of manufacturing. One example method includes providing an internal combustion engine having a plurality of cylinders allocated between a first bank having a first cylinder head and a second bank having a second cylinder head. The first bank and the second bank define a medial space therebetween. The method also includes fluidly coupling an exhaust system to the internal combustion engine. The exhaust system includes an aftertreatment system disposed at least in part at the medial space between the first bank and the second bank.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1A is a schematic diagram illustrating certain components of an internal combustion vehicle, according to an example embodiment.

FIG. 1B is a cross-sectional view of an example internal combustion engine with an associated aftertreatment system, as used in the vehicle of FIG. 1A.

FIG. 2 is a schematic diagram illustrating additional components of the internal combustion vehicle of FIG. 1A.

FIGS. 3A-3O are schematic diagrams of alternative arrangements of aftertreatment system components in the vehicle of FIG. 1A.

### DETAILED DESCRIPTION

Following below are more detailed descriptions of various concepts related to, and embodiments of, vehicles having exhaust aftertreatment systems. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

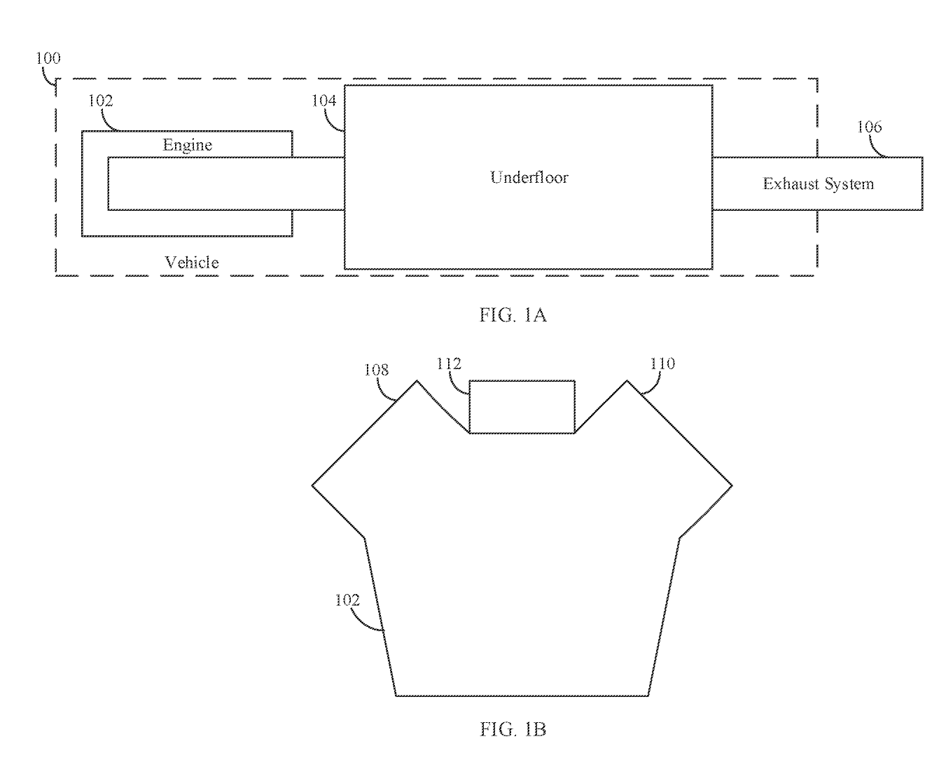

FIG. 1A is a representation of an apparatus, for example a vehicle 100, including an engine 102, an underfloor 104 and an exhaust system 106. The vehicle 100 may be any of a variety of passenger and/or cargo transporting vehicles, utility vehicles, and the like, each of which being powered by an internal combustion engine (e.g., the engine 102). The engine 102 is a source of mechanical force used to drive operations performed by the vehicle 100 (e.g., to rotate one or more wheels for movement, to actuate one or more hydraulic systems, etc.). Common arrangements of the engine 102 consume diesel or unleaded fuel to generate mechanical force while producing heat and an exhaust gas (i.e., including regulated emissions) as a waste product. The underfloor 104 in some arrangements is an external area of the vehicle 100 that may be occupied by at least a portion of the exhaust system 106. In some arrangements, the underfloor 104 is below one or more panels disposed across a bottom portion of the vehicle 100. In some such arrangements, the underfloor 104 is an area below a floor portion of a passenger cabin.

Exhaust gas is routed away from the engine 102 by the exhaust system 106. The exhaust system 106 may include a network of conduits, chambers, treatment systems (e.g., exhaust gas aftertreatment systems, as described in more detail below), and the like. In some arrangements, the exhaust system 106 originates at the engine 102, is disposed across a portion of the underfloor 104, and terminates at a tailpipe portion, at which point a gas flow within exits the exhaust system 106 into the atmosphere.

Referring to FIG. 1B, the engine 102 includes a plurality of cylinders housing a corresponding plurality of reciprocating pistons. Portions of air and fuel are cyclically collected and ignited in each of the plurality of cylinders to drive the movement of the corresponding plurality of pistons. As a result of each ignition cycle, exhaust gas and heat are produced in each of the plurality of cylinders. The plurality of cylinders are allocated to a first bank 108 and a second bank 110. Each of the first bank 108 and the second bank 110 includes a corresponding cylinder head and a corresponding set of cylinders and pistons. Each corresponding cylinder head may be disposed across distal ends (i.e., outermost ends) of the cylinders in each bank.

As used herein, a “medial space” refers to an area defined by a space between each of the two cylinder heads (i.e., where the cylinder heads protrude from the engine block). As shown in FIG. 1B, the engine 102 is formed such that the first bank 108 and the second bank 110 are disposed at a nonzero angle relative to each other, forming a “V” shape. The “V” shape of the banks includes a proximal end, where a first plane defined by the first bank 108 intersects with a second plane defined by the second bank 110, and distal ends corresponding to each branch of the “V” shape. In addition, a respective cylinder head is disposed at the distal end of each of the first bank 108 and the second bank 110. In the engine 102, the “V” shape defines a medial space between the first bank 108 and the second bank 110.

In particular embodiments the aftertreatment system 112 is integrated into the exhaust system 106 and may include any of several different components to reduce the levels of regulated pollutants present in exhaust gas produced by the engine 102. For example, the exhaust aftertreatment system 112 may include various components, such as a diesel oxidation catalyst, a selective catalytic reduction (SCR) catalyst, a diesel particulate filter, an SCR on filter and/or an ammonia slip catalyst (ASC) (also referred to as an ammonia oxidation catalyst (AMOX)). Each of the oxidation catalyst, the SCR catalyst, the particulate filter, the SCR on filter and the ASC components are configured to perform a particular exhaust emissions treatment operation on the exhaust gas passing through or over the respective components.

Generally, oxidation catalysts reduce the amount of CO and HCs present in the exhaust gas via oxidation techniques, as well as convert NO to NO₂ for passive regeneration of soot on a particulate filter and to facilitate fast SCR reactions. Particulate filters filter particulate matter, including soot, present in the exhaust gas. SCR catalysts and SCR on filter systems have been developed to remove NOₓ from the exhaust gas, which is relatively more difficult to remove than CO, HC and particulate matter.

SCR catalysts are configured to convert NOₓ (i.e., NO and NO₂ in some fraction) into nitrogen gas (i.e., N₂) and water vapor (i.e., H₂O). A reductant (e.g., typically ammonia (NH₃) in some form) is added to the exhaust gas upstream of the catalyst. The NOₓ and NH₃ pass over the catalyst and a catalytic reaction takes place in which NOₓ and NH₃ are converted into N₂ and H₂O. An SCR on filter is an assembly that performs the combined functions of an SCR and a particulate filter.

In many conventional SCR and SCR on filter systems, NH₃ is used as a reductant. Typically, pure NH₃ is not directly used due to safety concerns, expense, weight, lack of infrastructure, and other factors. Instead, many conventional systems utilize diesel exhaust fluid (DEF), which typically is a urea-water solution. To convert the DEF into NH₃, the DEF is injected into a decomposition tube through which an exhaust stream flows. The injected DEF spray is heated by the exhaust gas stream to vaporize the urea-water solution and trigger the decomposition of urea into NH₃. The exhaust gas mixture, including the NH₃ decomposed from the urea, further mixes while flowing through the decomposition tube and passes over the SCR catalyst, where the NOₓ and NH₃ are converted primarily to N₂ and H₂O. As such, a sufficient application of heat to the aftertreatment system 112 is an important aspect of managing regulated emissions in exhaust gas.

As shown in FIG. 1B, the aftertreatment system 112 is disposed on the engine 102 at the medial space between the first bank 108 and the second bank 110. As such, the aftertreatment system 112 is disposed in close proximity to the source of gas flow heat (i.e., the engine 102) and is also exposed to heat radiating from the engine 102 itself. In some arrangements, the aftertreatment system 112 includes one or more conduits or chambers that are engaged to the engine 102 itself (e.g., via one or more bolts, clamps, or other fasteners engaging the aftertreatment system 112 to a surface feature of the engine 102). In some arrangements, the exhaust system 106 is formed such that it routes the aftertreatment system 112 between the first bank 108 and the second bank 110, thereby positioning the aftertreatment system 112 without engaging it (i.e., without fastening the aftertreatment 112 itself to the engine 102 itself) to the engine 102.

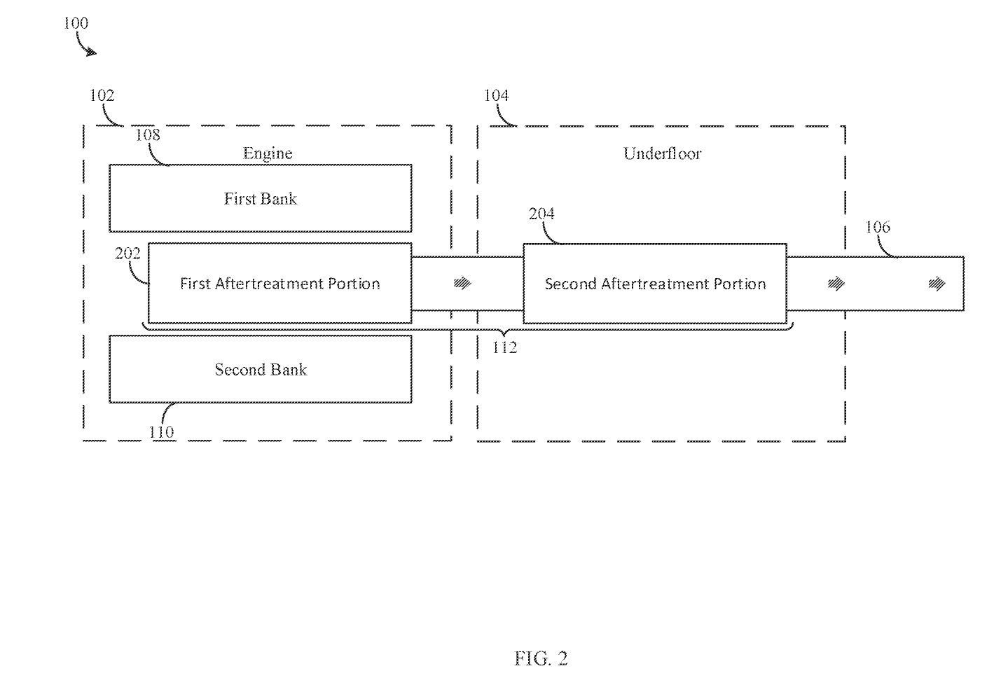

Referring now to FIG. 2, a top-down schematic view of the vehicle shows that the at least a portion of the aftertreatment system 112 is disposed in the medial space between the first bank 108 and the second bank 110. In some arrangements, the entire aftertreatment system 112 is disposed in the medial space. In other arrangements, however, components of the aftertreatment system 112 are allocated between a first aftertreatment portion 202 disposed at the medial space and a second aftertreatment portion 204 that is disposed elsewhere on the vehicle. For example, in some such arrangements, the first aftertreatment portion 202 is disposed at the medial space between the first bank 108 and the second bank 110 of the engine 102, while the second aftertreatment portion 204 is disposed in the underfloor 104 of the vehicle 100. As such, more heat-dependent components of the aftertreatment system 112 may be included at the first aftertreatment portion 202 to take advantage of its close proximity to the engine 102. At the same time, components of the aftertreatment system 112 that are less heat-dependent may be disposed at the second aftertreatment portion 204 in an area with more available space (e.g., the underfloor 104).

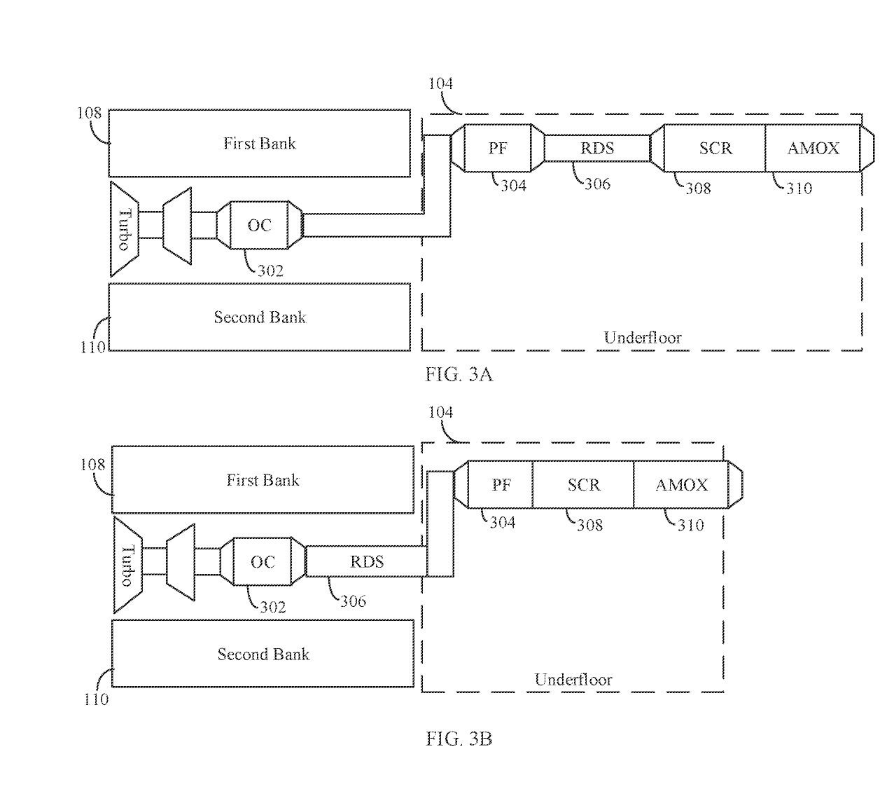

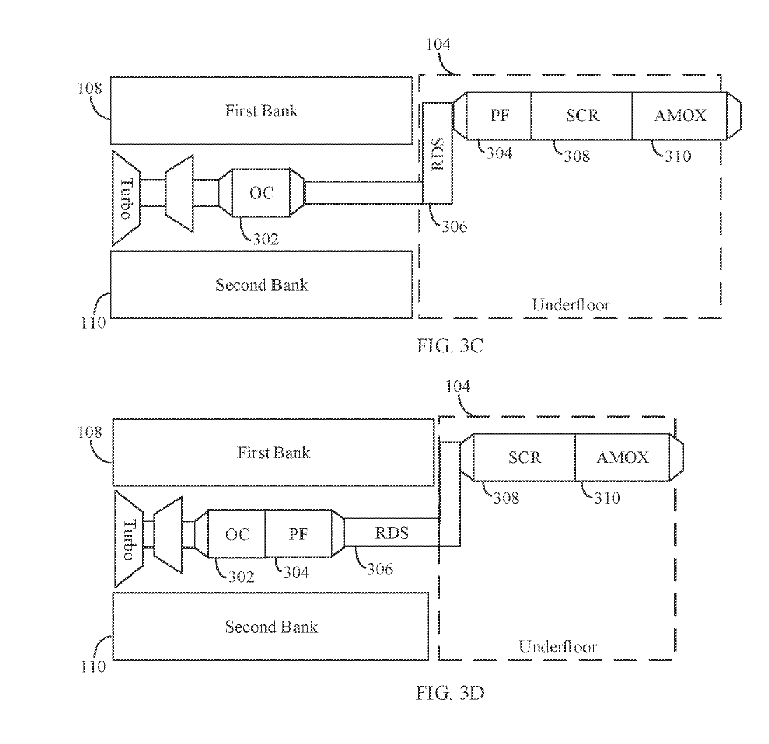

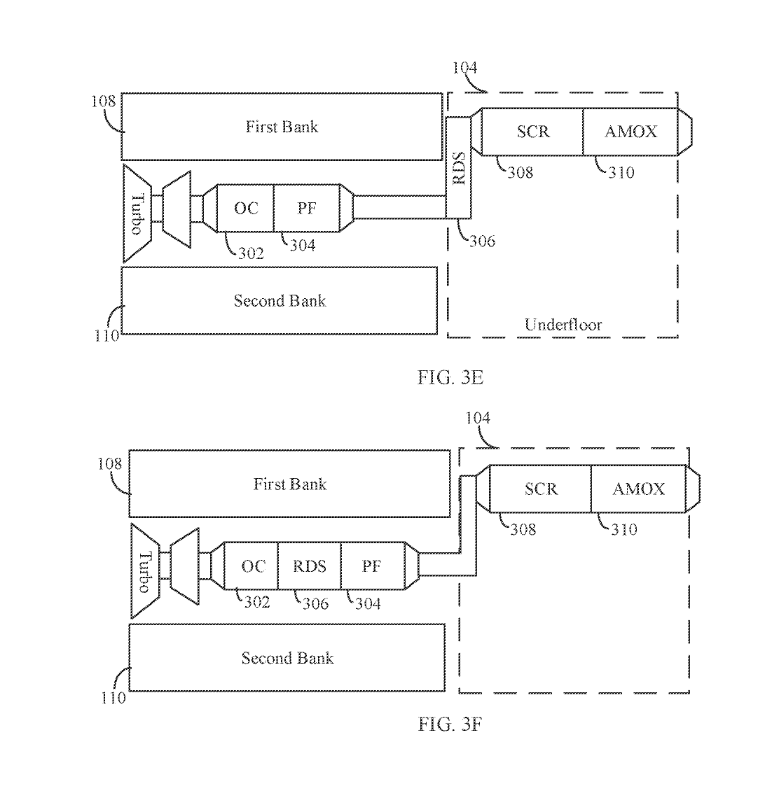

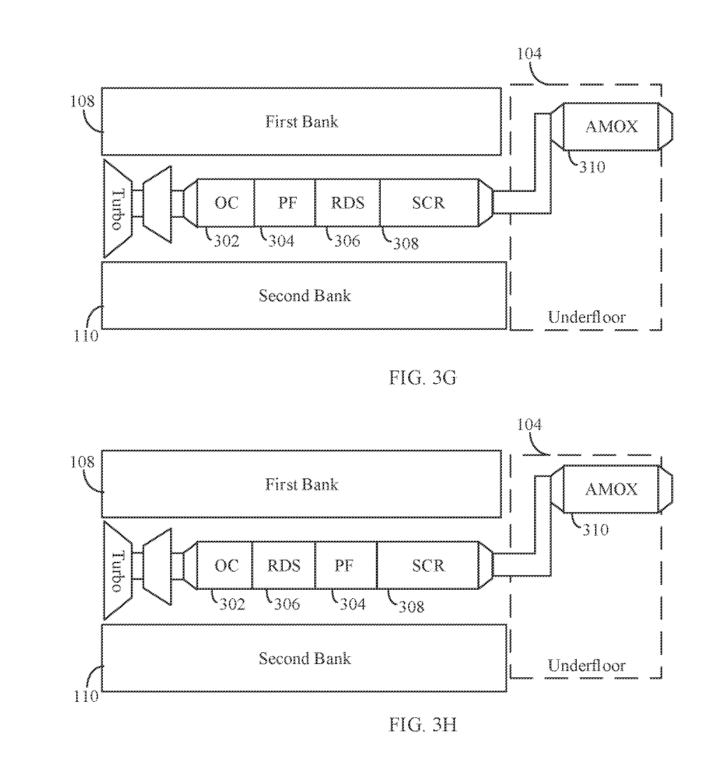

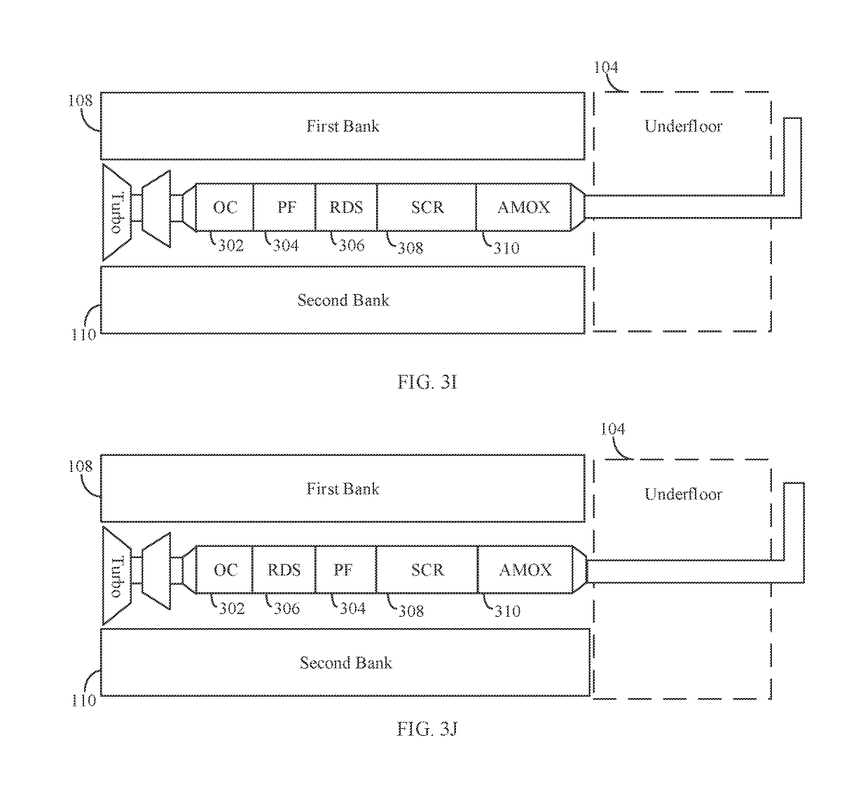

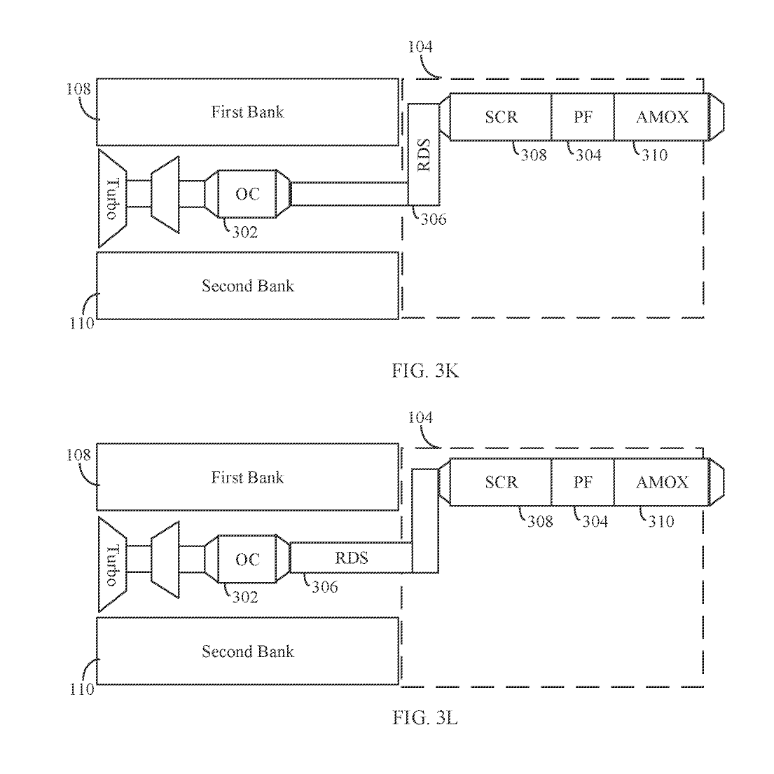

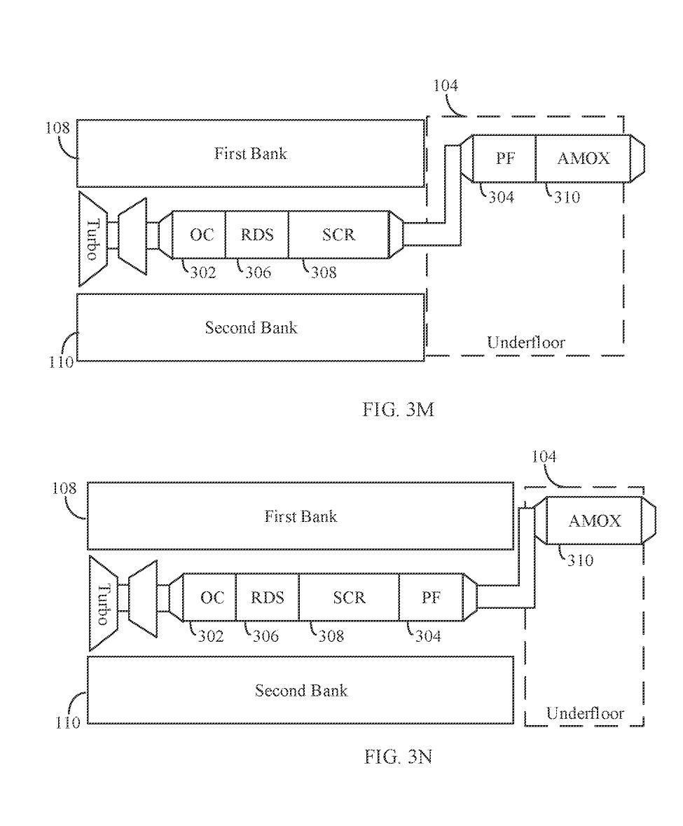

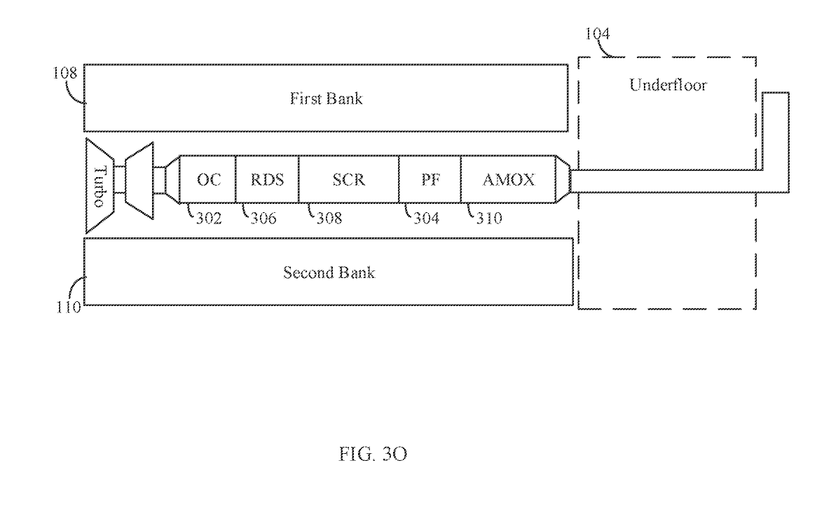

Example arrangements of allocations of the aftertreatment system 112 components are discussed with respect to FIGS. 3A-3O, below. As shown in FIGS. 3A-3O, the first bank 108 and the second bank 110 define a medial space where all or part of the aftertreatment system 112 may be disposed. It should be noted that, while the representations of the first bank 108 and the second bank 110 are shown in parallel in each of the schematic images of FIGS. 3A-3O to demonstrate the location of a medial space, the cylinder banks in accordance with embodiments described herein are disposed at one of various non-zero angles relative to each other. As such, each of the configurations shown in FIGS. 3A-3O may be arranged with cylinder banks disposed in a “V” shape defined by the first bank 108 and the second bank 110. Referring to FIG. 3A, in one arrangement, located in the medial space between the first bank 108 and the second bank 110 is an oxidation catalyst 302 which could also be a Partial NOₓ Absorber (PNA) or a Lean NOₓ Trap (LNT). Located outside the “V” engine block/head assembly and downstream of the oxidation catalyst is a particulate filter 304 which could also have a catalyzed washcoat applied to it. Located downstream of the particulate filter 304 is a Reductant Delivery System (RDS) 306, which includes either a gaseous ammonia or DEF injector. Located downstream of the RDS 306 is the SCR 308. Located downstream of the SCR 308 is the AMOX 310. The AMOX 310 is optional for the layouts discussed with respect to FIGS. 3A-3O.

Referring now to FIG. 3B, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located outside of the “V” engine block/head assembly and downstream of the RDS 306 is the particulate filter 304 which can have the addition of a SCR washcoat applied to it. Located downstream of the particulate filter 304 is the SCR 308. The SCR 308 is optional for this layout and might not be needed in for all applications. Located downstream of the SCR 308 is the AMOX 310.

Referring now to FIG. 3C, in one arrangement, located in the medial space between the first bank 108 and the second bank 110 is an oxidation catalyst 302 which could also be a PNA or an LNT. Located outside the “V” engine block/head assembly and downstream of the oxidation catalyst 302 is the RDS 306, which includes either a gaseous ammonia or DEF injector. Located downstream of the RDS 306 is the particulate filter 304 which can have the addition of a SCR washcoat applied to it. Located downstream the particulate filter 304 is the SCR 308. The SCR 308 is optional for this layout and might not be needed in for all applications. Located downstream of the SCR 308 is the AMOX 310.

Referring now to FIG. 3D, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is a particulate filter 304 which could also have a catalyzed washcoat applied to it. Located in the middle/plane of the “V” engine block/head assembly and downstream of the particulate filter 304 is the RDS 306, which includes either a gaseous ammonia or DEF injector. Located outside of the “V” engine block/head assembly and downstream of the RDS 306 is the SCR 308. Located downstream of the SCR 308 is the AMOX 310.

Referring now to FIG. 3E, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is a particulate filter 304 which could also have a catalyzed washcoat applied to it. Located outside of the “V” engine block/head assembly and downstream of the particulate filter 304 is the RDS 306, which includes either a gaseous ammonia or DEF injector. Located downstream of the RDS 306 is the SCR 308. Located downstream of the SCR 308 is the AMOX 310.

Referring now to FIG. 3F, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located in the middle/plane of the “V” engine block/head assembly and downstream of the RDS 306 is the particulate filter 304 which can have the addition of a SCR washcoat applied to it. Located outside of the “V” engine block/head assembly and downstream of the particulate filter 304 is the SCR 308. The SCR 308 is optional for this layout and might not be needed in for all applications. Located downstream of the SCR 308 is the AMOX 310.

Referring now to FIG. 3G, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is a particulate filter 304 which could also have a catalyzed washcoat applied to it. Located in the middle/plane of the “V” engine block/head assembly and downstream of the particulate filter 304 is the RDS 306, which includes either a gaseous ammonia or DEF injector. Located in the middle/plane of the “V” engine block/head assembly and downstream of the RDS 306 is the SCR 308. Located outside of the “V” engine block/head assembly and downstream of the SCR 308 is the AMOX 310.

Referring now to FIG. 3H, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located in the middle/plane of the “V” engine block/head assembly and downstream of the RDS 306 is the particulate filter 304 which can have the addition of a SCR washcoat applied to it. Located in the middle/plane of the “V” engine block/head assembly and downstream of the particulate filter 304 is the SCR 308. The SCR 308 is optional for this layout and might not be needed in for all applications. Located outside of the “V” engine block/head assembly and downstream of the SCR 308 is the AMOX 310.

Referring now to FIG. 3I, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is a particulate filter 304 which could also have a catalyzed washcoat applied to it. Located in the middle/plane of the “V” engine block/head assembly and downstream of the particulate filter 304 is the RDS 306, which includes either a gaseous ammonia or DEF injector. Located in the middle/plane of the “V” engine block/head assembly and downstream of the RDS 306 is the SCR 308. Located in the middle/plane of the “V” engine block/head assembly and downstream of the SCR 308 is the AMOX 310.

Referring now to FIG. 3J, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located in the middle/plane of the “V” engine block/head assembly and downstream of the RDS 306 is the particulate filter 304 which can have the addition of a SCR washcoat applied to it. Located in the middle/plane of the “V” engine block/head assembly and downstream of the particulate filter 304 is the SCR 308. The SCR 308 is optional for this layout and might not be needed in for all applications. Located in the middle/plane of the “V” engine block/head assembly and downstream of the SCR 308 is the AMOX 310.

Referring now to FIG. 3K, in one arrangement, located in the medial space between the first bank 108 and the second bank 110 is an oxidation catalyst 302 which could also be a PNA or an LNT. Located outside of the “V” engine block/head assembly and downstream of the oxidation catalyst 302 is the RDS 306, which includes either a gaseous ammonia or DEF injector. Located downstream of the RDS 306 is the SCR 308. Located downstream of the SCR 308 is the particulate filter 304 which can have the addition of a SCR or catalyzed washcoat applied to it. Located after the particulate filter 304 is the AMOX 310.

Referring now to FIG. 3L, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located outside of the “V” engine block/head assembly and downstream of the RDS 306 is the SCR 308. Located downstream of the SCR 308 is the particulate filter 304 which can have the addition of a SCR or catalyzed washcoat applied to it. Located after the particulate filter 304 is the AMOX 310.

Referring now to FIG. 3M, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located in the middle/plane of the “V” engine block/head assembly and downstream of the RDS 306 is the SCR 308. Located outside of the “V” engine block/head assembly and downstream of the SCR 308 is the particulate filter 304 which can have the addition of a SCR or catalyzed washcoat applied to it. Located downstream of the particulate filter 304 is the AMOX 310.

Referring now to FIG. 3N, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located in the middle/plane of the “V” engine block/head assembly and downstream of the RDS 306 is the SCR 308. Located in the middle/plane of the “V” engine block/head assembly and downstream of the SCR 308 is the particulate filter 304 which can have the addition of a SCR or catalyzed washcoat applied to it. Located outside of the “V” engine block/head assembly and downstream of the particulate filter 304 is the AMOX 310.

Referring now to FIG. 3O, in one arrangement, located in the medial space between the first bank 108 and the second bank 110 is an oxidation catalyst 302 which could also be a PNA or an LNT. Located in the middle/plane of the “V” engine block/head assembly and downstream of the oxidation catalyst 302 is the RDS 306, which includes either a gaseous ammonia or DEF injector. Located in the middle/plane of the “V” engine block/head assembly and downstream of the RDS 306 is the SCR 308. Located in the middle/plane of the “V” engine block/head assembly and downstream of the SCR 308 is the particulate filter 304 which can have the addition of a SCR or catalyzed washcoat applied to it. Located in the middle/plane of the “V” engine block/head assembly and downstream of the particulate filter 304 is the AMOX 310.

For the purpose of this disclosure, the term and “engaged” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other example embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that, unless otherwise noted, any parameters, dimensions, materials, and configurations described herein are meant to be example and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An apparatus, comprising:
an internal combustion engine having a plurality of cylinders allocated between a first bank having a first cylinder head and a second bank having a second cylinder head, the first bank and the second bank defining a medial space therebetween; and
an exhaust system in fluid receiving communication with the internal combustion engine and in fluid providing communication with the atmosphere, the exhaust system comprising an aftertreatment system disposed at least in part at the medial space between the first bank and the second bank.

2. The apparatus of claim 1, wherein the first bank is disposed at a nonzero angle with respect to the second bank.

3. The apparatus of claim 1, wherein the aftertreatment system is entirely disposed at the medial space between the first bank and the second bank.

4. The apparatus of claim 1, wherein the aftertreatment system is fastened to the internal combustion engine.

5. The apparatus of claim 1, further comprising a floor portion of a vehicle,
wherein components of the aftertreatment system are divided into a first aftertreatment portion and a second aftertreatment portion;
wherein the first aftertreatment portion is disposed at the medial space; and
wherein the second aftertreatment portion is disposed between the floor portion of the vehicle and the ground.

6. The apparatus of claim 5,
wherein the first aftertreatment portion includes an oxidation catalyst; and
wherein the second aftertreatment portion includes a particulate filter, a reductant delivery system positioned downstream of the particulate filter, and a selective catalytic reduction catalyst positioned downstream of the reductant delivery system.

7. The apparatus of claim 5,
wherein the first aftertreatment portion includes an oxidation catalyst and a reductant delivery system positioned downstream of the oxidation catalyst; and
wherein the second aftertreatment portion includes a particulate filter and a selective catalytic reduction catalyst positioned downstream of the particulate filter.

8. The apparatus of claim 5,
wherein the first aftertreatment portion includes an oxidation catalyst; and
wherein the second aftertreatment portion includes a reductant delivery system, a particulate filter positioned downstream of the reductant delivery system, and a selective catalytic reduction catalyst positioned downstream of the particulate filter.

9. The apparatus of claim 5,
wherein the first aftertreatment portion includes an oxidation catalyst, a particulate filter positioned downstream of the oxidation catalyst, and a reductant delivery system positioned downstream of the particulate filter; and
wherein the second aftertreatment portion includes a selective catalytic reduction catalyst.

10. The apparatus of claim 5,
wherein the first aftertreatment portion includes an oxidation catalyst and a particulate filter positioned downstream of the oxidation catalyst; and
wherein the second aftertreatment portion includes a reductant delivery system and a selective catalytic reduction catalyst positioned downstream of the reductant delivery system.

11. The apparatus of claim 5,
wherein the first aftertreatment portion includes an oxidation catalyst, a reductant delivery system positioned downstream of the oxidation catalyst, and a particulate filter positioned downstream of the reductant delivery system; and
wherein the second aftertreatment portion includes a selective catalytic reduction catalyst.

12. The apparatus of claim 5,
wherein the first aftertreatment portion includes an oxidation catalyst, a particulate filter positioned downstream of the oxidation catalyst, a reductant delivery system positioned downstream of the particulate filter, and a selective catalytic reduction catalyst positioned downstream of the reductant delivery system; and
wherein the second aftertreatment portion includes an ammonia oxidation catalyst.

13. The apparatus of claim 5,
wherein the first aftertreatment portion includes an oxidation catalyst, a reductant delivery system positioned downstream of the oxidation catalyst, a particulate filter positioned downstream of the reductant delivery system, and a selective catalytic reduction catalyst positioned downstream of the reductant delivery system; and
wherein the second aftertreatment portion includes an ammonia oxidation catalyst.

14. The apparatus of claim 5, wherein the first aftertreatment portion includes an oxidation catalyst, a particulate filter positioned downstream of the oxidation catalyst, a reductant delivery system positioned downstream of the particulate filter, a selective catalytic reduction catalyst positioned downstream of the reductant delivery system, and an ammonia oxidation catalyst positioned downstream of the selective catalytic reduction catalyst.

15. The apparatus of claim 5, wherein the first aftertreatment portion includes an oxidation catalyst, a reductant delivery system positioned downstream of the oxidation catalyst, a particulate filter positioned downstream of the reductant delivery system, a selective catalytic reduction catalyst positioned downstream of the particulate filter, and an ammonia oxidation catalyst positioned downstream of the selective catalytic reduction catalyst.

16. The apparatus of claim 5,
wherein the first aftertreatment portion includes an oxidation catalyst; and
wherein the second aftertreatment portion includes a reductant delivery system, a selective catalytic reduction catalyst positioned downstream of the reductant delivery system, and a particulate filter positioned downstream of the selective catalytic reduction catalyst.

17. The apparatus of claim 5,
wherein the first aftertreatment portion includes an oxidation catalyst and a reductant delivery system positioned downstream of the oxidation catalyst; and
wherein the second aftertreatment portion includes a selective catalytic reduction catalyst and a particulate filter positioned downstream of the oxidation catalyst.

18. The apparatus of claim 5,
wherein the first aftertreatment portion includes an oxidation catalyst, a reductant delivery system positioned downstream of the oxidation catalyst, and a selective catalytic reduction catalyst positioned downstream of the reductant delivery system; and
wherein the second aftertreatment portion includes a particulate filter.

19. The apparatus of claim 5,
wherein the first aftertreatment portion includes an oxidation catalyst, a reductant delivery system positioned downstream of the oxidation catalyst, a selective catalytic reduction catalyst positioned downstream of the reductant delivery system, and a particulate filter positioned downstream of the selective catalytic reduction catalyst; and
wherein the second aftertreatment portion includes an ammonia oxidation catalyst.

20. The apparatus of claim 5, wherein the first aftertreatment portion includes an oxidation catalyst, a reductant delivery system positioned downstream of the oxidation catalyst, a selective catalytic reduction catalyst positioned downstream of the reductant delivery system, a particulate filter positioned downstream of the selective catalytic reduction catalyst, and an ammonia oxidation catalyst positioned downstream of the particulate filter.

21. A method, comprising:
providing an internal combustion engine having a plurality of cylinders allocated between a first bank having a first cylinder head and a second bank having a second cylinder head, the first bank and the second bank defining a medial space therebetween; and
fluidly coupling an exhaust system to the internal combustion engine, the exhaust system comprising an aftertreatment system disposed at least in part at the medial space between the first bank and the second bank.

22. The method of claim 21, wherein the aftertreatment system is entirely disposed at the medial space between the first bank and the second bank.

23. The method of claim 21,
wherein components of the aftertreatment system are divided into a first aftertreatment portion and a second aftertreatment portion;
wherein the first aftertreatment portion is disposed at the medial space; and
wherein the second aftertreatment portion is disposed between a floor portion of the vehicle and the ground.
